(19) United States
(12) Patent Application Publication
(10) Pub. No.: US 2024/0205378 A1
(43) Pub. Date: Jun. 20, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventors: HIROFUMI SHIMADA, TOKYO (JP); KAZUKI YOKOYAMA, TOKYO (JP); TSUTOMU ICHINOSE, TOKYO (JP); RURI OYA, TOKYO (JP); KOJI AOYAMA, TOKYO (JP)

(21) Appl. No.: 18/554,934

(22) PCT Filed: Mar. 1, 2022
(86) PCT No.: PCT/JP2022/008534

§ 371 Date: Oct. 11, 2023

(30) Foreign Application Priority Data
Apr. 28, 2021 (JP) 2021-076289

(51) Int. Cl. H04N 13/111; G06T 7/50; G06T 7/73; H04N 13/00; H04N 13/302; H04N 13/398

(52) U.S. Cl. CPC H04N 13/111; G06T 7/50; G06T 7/73; H04N 13/302; G06T 2207/10024; G06T 2207/30201; G06T 2207/30204; H04N 2013/0077; H04N 2013/0081; H04N 2013/0096; H04N 13/398

(57) ABSTRACT

The information processing device includes an image analysis unit (A4-i) and a content rendering unit. The image analysis unit (A4-i) generates spatial position/range information (D4) of a virtual space in which a spatial display performs 3D display based on a captured image of a marker displayed on the spatial display. The content rendering unit performs rendering processing of the spatial video presented in the virtual space, based on the spatial position/range information (D4) and a viewpoint position.

### FIELD

The present invention relates to an information processing device, an information processing method, and a program.

### BACKGROUND

A spatial display with an inclined screen is known as a type of autostereoscopic (glass-free three-dimensional (3D)) displays. This type of display has an inclined screen, which allows providing a wide viewing angle range in which the spatial video can be perceived. In addition, since the virtual space is stretched in a rectangular parallelepiped region having the screen as a diagonal plane, the depth that can be expressed is also wide.

### CITATION LIST

### Patent Literature

Patent Literature 1: JP 2018-187909 A
Patent Literature 2: JP 2018-172773 A
Patent Literature 3: JP 2018-179420 A

### SUMMARY

### Technical Problem

There has been a study to display a wide-area scene by arranging a plurality of spatial displays. In this case, there is a need to accurately specify the position and range of a virtual space in which a spatial video is presented. However, with the conventional methods disclosed in Patent Literatures 1 to 3 and the like, the position and posture of the device can be detected, but the stretch of the virtual space in the depth direction (inclination direction of the screen) cannot be specified.

In view of this, the present disclosure proposes an information processing device, an information processing method, and a program capable of accurately specifying the position and range of the virtual space of the spatial display.

### Solution to Problem

According to the present disclosure, an information processing device is provided that comprises: an image analysis unit that generates spatial position/range information of a virtual space in which a spatial display performs 3D display, based on a captured image of a marker displayed on the spatial display; and a content rendering unit that performs rendering processing on a spatial video presented in the virtual space, based on the spatial position/range information and a viewpoint position. According to the present disclosure, an information processing method in which an information process of the information processing device is executed by a computer, and a program for causing the computer to execute the information process of the information processing device, are provided.

### BRIEF DESCRIPTION OF DRAWINGS

FIG. 1 is a diagram illustrating a schematic configuration of a display system according to a first embodiment.

FIG. 2 is a block diagram illustrating a functional configuration of a spatial display.

FIG. 3 is a diagram illustrating a schematic shape of a spatial display.

FIG. 4 is a block diagram illustrating a functional configuration of a spatial video reproduction device.

FIG. 5 is a diagram illustrating an example of a spatial region marker image.

FIG. 6 is a diagram illustrating a state in which a spatial region marker image is displayed on each spatial display.

FIG. 7 is a diagram of a spatial region marker image of each spatial display viewed from a camera viewpoint.

FIG. 8 is a diagram illustrating a variation of relative positions of a screen, an installation surface, and a virtual space.

FIG. 9 is a diagram illustrating a variation of relative positions of a screen, an installation surface, and a virtual space.

FIG. 10 is a diagram illustrating a variation of a spatial region marker image.

FIG. 11 is a diagram illustrating a variation of a spatial region marker image.

FIG. 12 is a diagram illustrating a variation of a spatial region marker image.

FIG. 13 is a diagram illustrating a variation of a spatial region marker image.

FIG. 14 is a diagram illustrating a variation of a spatial region marker image.

FIG. 15 is a diagram illustrating a variation of a spatial region marker image.

FIG. 16 is a diagram illustrating a variation of a spatial region marker image.

FIG. 17 is a block diagram illustrating a functional configuration of a spatial information measuring/managing device.

FIG. 18 is a block diagram illustrating a functional configuration of the spatial region marker imaging device.

FIG. 19 is a diagram illustrating an overall sequence of information processing performed by a display system.

FIG. 20 is a flowchart illustrating spatial information measurement processing.

FIG. 21 is a state transition diagram of the spatial video reproduction device.

FIG. 22 is a flowchart of reproduction processing.

FIG. 23 is a diagram illustrating a hardware configuration example of a display system.

FIG. 24 is a diagram illustrating a schematic configuration of a display system according to a second embodiment.

FIG. 25 is a diagram illustrating a schematic configuration of a display system according to a third embodiment.

FIG. 26 is a diagram illustrating a schematic configuration of a display system according to a fourth embodiment.

FIG. 27 is a diagram illustrating a schematic configuration of a display system according to a fifth embodiment.

FIG. 28 is a diagram illustrating a schematic configuration of a display system according to a sixth embodiment.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

Note that the description will be given in the following order.
[1. First embodiment]
[1-1. Configuration of display system]
[1-1-1. Spatial display]
[1-1-2. Spatial video reproduction device]
[1-1-3. Spatial region marker image]
[1-1-4. Spatial information measuring/managing device]
[1-1-5. Spatial region marker imaging device]
[1-2. Information processing method]
[1-2-1. Spatial information measurement processing]
[1-2-2. Spatial video reproduction processing]
[1-3. Hardware configuration example]
[1-4. Effects]
[2. Second embodiment]
[3. Third embodiment]
[4. Fourth embodiment]
[5. Fifth Embodiment]
[6. Sixth Embodiment]

### 1. First Embodiment

### 1-1. Configuration of Display System

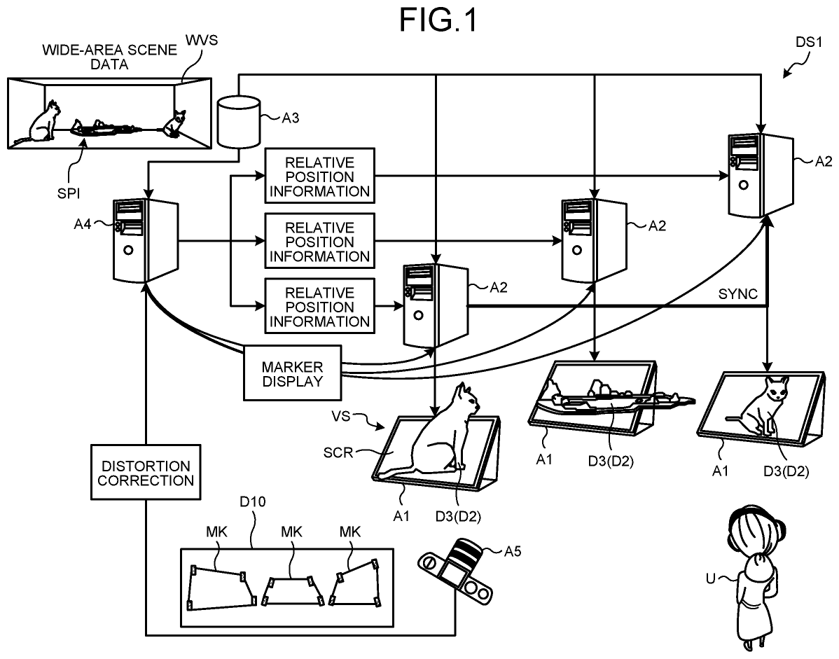

FIG. 1 is a diagram illustrating a schematic configuration of a display system DS1 according to a first embodiment.

The display system DS1 includes one or more spatial displays A1. The spatial display A1 is an autostereoscopic (glass-free 3D) display in which a screen SCR is inclined to enhance video representation. The number of spatial displays A1 is not limited. In the example of FIG. 1, the display system DS1 includes a plurality of (for example, three) spatial displays A1. The plurality of spatial displays A1 arranged in line provides a wide-area virtual space WVS capable of displaying a wide-area scene SPI.

The display system DS1 includes: a spatial video accumulation device A3 that stores wide-area scene data; and one or more spatial video reproduction devices A2 that divide and display the wide-area scene SPI on one or more spatial displays A1. In the example of FIG. 1, one spatial video reproduction device A2 is provided for each spatial display A1. The spatial video reproduction device A2 extracts a spatial video D3 corresponding to the installation position of the corresponding spatial display A1 from the wide-area scene SPI. The spatial display A1 performs 3D display of the extracted spatial video D3 in the virtual space VS. The example of FIG. 1 displays a scene in which two cats are sitting around a pond as the wide-area scene SPI. The images of two cats and a pond are separately displayed on three spatial displays A1.

The display system DS1 includes a spatial information measuring/managing device A4 that measures and manages spatial information. The spatial information includes, for example, spatial position/range information D4 of each spatial display A1. The spatial position/range information D4 includes information related to the position and range of the virtual space VS of the spatial display A1. The spatial information is measured using a spatial region marker image MK. The spatial region marker image MK is an image analysis marker displayed on the spatial display A1.

For example, the display system DS1 includes a spatial region marker imaging device A5 that captures the spatial region marker image MK displayed on the spatial display A1. Examples of the spatial region marker imaging device A5 include a wide-angle camera, a fisheye camera, or a 360 degree camera (omnidirectional camera) capable of capturing the spatial region marker image MK of each spatial display A1 in the same field of view.

For example, the spatial information measuring/managing device A4 performs distortion correction on the captured image (an entire scene image D10) of the spatial region marker image MK, and analyzes the corrected captured image using a known method such as a Perspective-N-Points (PnP) method. The spatial information measuring/managing device A4 generates information (position/posture information) related to the position and posture of the screen SCR based on the analysis result of the captured image. The spatial information measuring/managing device A4 detects the position and range of the virtual space VS based on the position/posture information of the screen SCR. The spatial video reproduction device A2 determines the range of the spatial video D3 to be extracted from the wide-area scene SPI based on the spatial information of the corresponding spatial display A1.

The spatial display A1, the spatial video reproduction device A2, the spatial video accumulation device A3, the spatial information measuring/managing device A4, and the spatial region marker imaging device A5 are connected in a wired or wireless communication.

### [1-1-1. Spatial Display]

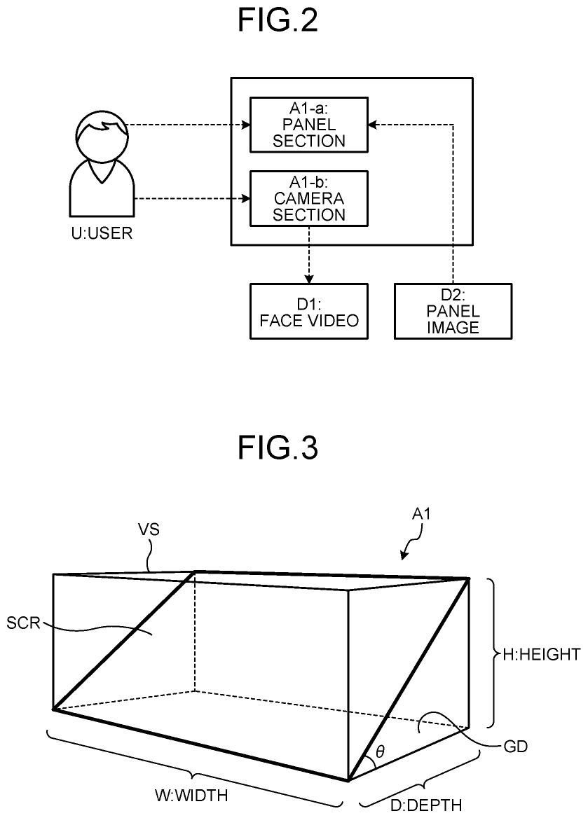

FIG. 2 is a block diagram illustrating a functional configuration of the spatial display A1. FIG. 3 is a diagram illustrating a schematic shape of the spatial display A1.

As illustrated in FIG. 3, the spatial display A1 is an autostereoscopic (glass-free 3D) display in which the screen SCR is inclined at an angle θ with respect to an installation surface GD. The installation surface GD is a plane in the real space where the spatial display A1 is installed. The installation surface GD may be a horizontal plane or a plane inclined from the horizontal plane. The angle θ is flexibly designed according to the size of the virtual space VS desired. In the example of FIG. 3, the installation surface GD is a horizontal plane, and the angle θ is 45°, for example.

Hereinafter, one of two sides of the screen SCR parallel to the installation surface GD, namely, a side closer to the installation surface GD is defined as a lower side, and the other side, that is, the side farther from the installation surface GD is defined as an upper side. A direction parallel to the lower side is defined as a width direction. A direction orthogonal to the lower side in a plane parallel to the installation surface GD is defined as a depth direction. A direction orthogonal to the width direction and the depth direction is defined as a height direction.

In the example of FIG. 3, the size of the screen SCR in the width direction is W, the size in the depth direction is D, and the size in the height direction is H. The virtual space VS is a rectangular parallelepiped space of W, D, and H in size in the width direction, the depth direction, and the height direction, respectively. A plurality of viewpoint images VI displayed on the screen SCR is presented in the virtual space VS as a 3D video.

As illustrated in FIG. 2, the spatial display A1 includes a panel section A1-a and a camera section A1-b. The panel section A1-a displays a panel image D2 generated by the spatial video reproduction device A2 on the screen SCR. The panel section A1-a is implemented by using a known display panel such as a liquid crystal display (LCD) or an organic light emitting diode (OLED).

The spatial video reproduction device A2 generates a virtual reality (VR) image and a spatial region marker image MK as the panel image D2. The VR image is an image for performing 3D display of the spatial video D3. The spatial region marker image MK is a two-dimensional measurement video for measuring spatial information of the spatial display A1. The VR image includes a plurality of viewpoint images. The viewpoint image represents a two-dimensional image viewed from one viewpoint. The plurality of viewpoint images includes a left eye image viewed from the left eye of a user U and a right eye image viewed from the right eye of the user U.

The camera section A1-b captures a face video D1 of the user U and transmits the face video D1 to the spatial video reproduction device A2. Applicable example of the camera section A1-b include a wide-angle camera, a fisheye camera, a 360 degree camera (omnidirectional camera) capable of imaging the outside world in a wide range. The spatial video reproduction device A2 detects the position of the face of the user U from the face video D1. The spatial video reproduction device A2 generates a panel image D2 enabling optimum stereoscopic vision at the detected position, and transmits the generated panel image D2 to the panel section A1-a. This implements appropriate 3D display corresponding to the viewpoint position of the user U.

### [1-1-2. Spatial Video Reproduction Device]

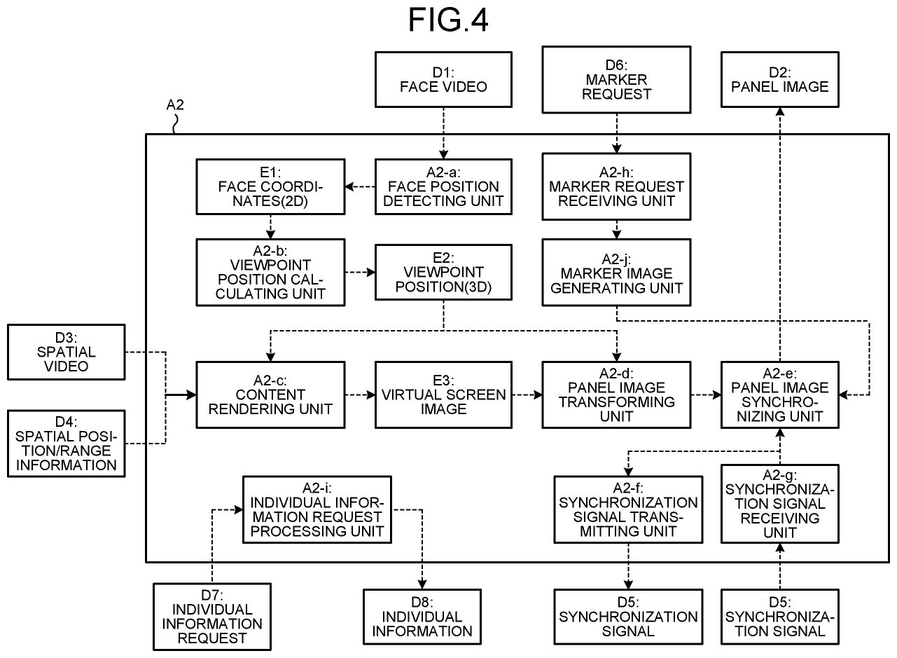

FIG. 4 is a block diagram illustrating a functional configuration of the spatial video reproduction device A2.

The spatial video reproduction device A2 includes: a face position detecting unit A2-a; a viewpoint position calculating unit A2-b; a content rendering unit A2-c; a panel image transforming unit A2-d; a panel image synchronizing unit A2-e; a synchronization signal transmitting unit A2-f or a synchronization signal receiving unit A2-g; a marker request receiving unit A2-h; and an individual information processing unit A2-i.

The face position detecting unit A2-a detects one or more feature points related to the position of the face from the face video D1. The face position detecting unit A2-a calculates face coordinates E1 from the detected one or more feature points. The face coordinates E1 are calculated as two-dimensional coordinates in the camera coordinate system, for example. The viewpoint position calculating unit A2-b calculates a viewpoint position E2 of the user U from the face coordinates E1. The viewpoint position E2 is calculated as three-dimensional coordinates in a three-dimensional space (real space).

Based on the spatial position/range information D4 and the viewpoint position E2, the content rendering unit A2-c performs rendering processing on the spatial video D3 presented in the virtual space VS. For example, the content rendering unit A2-c calculates the camera matrix in the three-dimensional space using the viewpoint position E2 and the spatial position/range information D4. The content rendering unit A2-c performs rendering processing on the spatial video D3 using the camera matrix to generate a virtual screen image E3. The panel image transforming unit A2-d transforms the virtual screen image E3 into the panel image D2.

For example, the content rendering unit A2-c assumes that a light field box (LFB) is located in the virtual space VS. The content rendering unit A2-c sets a frustum having a size including the entire panel section A1-a in the direction from the viewpoint position E2 to the center position of the panel section A1-a of the LFB, and draws the virtual screen image E3. In this state, the rendering image includes an image around the panel section A1-a. Therefore, the panel image transforming unit A2-d transforms the portion of the panel section A1-a in the image into a rectangle corresponding to the panel image D2 by geometric transformation referred to as homography transformation.

The operation of the panel image synchronizing unit A2-e varies as follows depending on whether the spatial video reproduction device A2 is Master or Slave.

In a case where the spatial video reproduction device A2 is Master, the panel image synchronizing unit A2-e transmits the panel image D2 to the spatial display A1, and at the same time, the synchronization signal transmitting unit A2-f generates a synchronization signal D5 and transmits the generated synchronization signal D5 to Salve. In a case where the spatial video reproduction device A2 is Slave, the panel image synchronizing unit A2-e waits until the synchronization signal receiving unit A2-g receives the synchronization signal D5, and simultaneously receives the synchronization signal D5 and transmits the panel image D2 to the spatial display A1.

The marker request receiving unit A2-h receives a marker request D6 from the spatial information measuring/managing device A4. The marker request receiving unit A2-h extracts a marker designation color C1 designated as a display color of the marker from the marker request D6. A marker image generating unit A2-j generates the spatial region marker image MK using the marker designation color C1. The panel image synchronizing unit transmits the spatial region marker image MK to the spatial display A1 as the panel image D2.

Having received individual information request D7 from the spatial information measuring/managing device A4, the individual information processing unit A2-i transmits individual information D8 corresponding to the connected spatial display A1 to the spatial information measuring/managing device A4.

### [1-1-3. Spatial Region Marker Image]

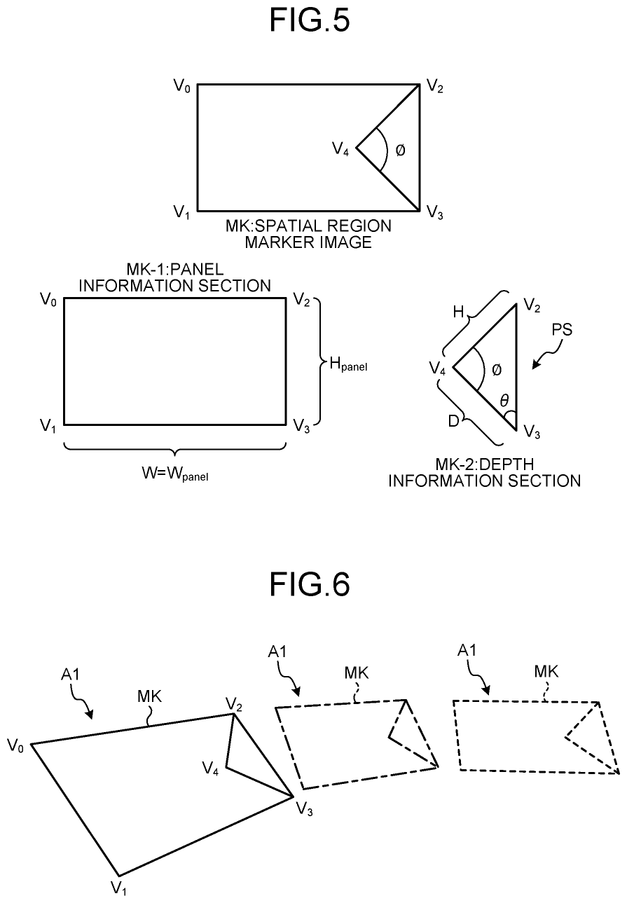

FIG. 5 is a diagram illustrating an example of the spatial region marker image MK.

The spatial region marker image MK includes a panel information section MK-1 and a depth information section MK-2, for example. The panel information section MK-1 indicates information related to the range of the screen SCR of the spatial display A1. The depth information section MK-2 indicates information related to the depth of the virtual space VS. The three-dimensional coordinates of the plurality of feature points (such as ends and corners of a straight line) included in the spatial region marker image MK are calculated by performing image analysis on the captured image of the spatial region marker image MK. Examples of method of image analysis include known methods such as a PnP method.

The panel information section MK-1 includes an image whose position, range, and size to be displayed on the screen SCR are specified in advance. The panel information section MK-1 includes three or more feature points that are not arranged on the same straight line.

In the example of FIG. 5, the panel information section MK-1 is generated as a rectangular frame-shaped image that rims an outer peripheral portion of the screen SCR. Four vertexes V₀, V₁, V₂, and V₃ of the panel information section MK-1 are extracted as feature points of the panel information section MK-1. The panel information section MK-1 is displayed as a thick line image or highlighted image so as to be an image with high visibility. A line segment V₀V₂ and a line segment V₁V₃ are parallel to each other. The ratio between the line segment V₀V₂ and the line segment V₁V₃ matches the ratio between the upper side and the lower side of the screen SCR. A line segment V₀V₁ and a line segment V₂V₃ are parallel to each other. The ratio between the line segment V₀V₁ and the line segment V₂V₃ matches the ratio between the left side and the right side of the screen SCR.

The relative position and the relative size between the panel information section MK-1 and the screen SCR are specified in advance. Therefore, the three-dimensional coordinates of the space occupied by the screen SCR are calculated based on the three-dimensional coordinates of the feature points V₀, V₁, V₂, and V₃ of the panel information section MK-1. The range of the screen SCR in the three-dimensional space is calculated based on the three-dimensional coordinates of the screen SCR.

The depth information section MK-2 includes an posture information image PS. The posture information image PS indicates posture information of the screen SCR with respect to the installation surface GD. In the example of FIG. 5, a triangle V₂V₃V₄ makes the posture information image PS. The triangle V₂V₃V₄ indicates a cross-sectional shape orthogonal to the width direction of the spatial display A1. Three vertexes V₂, V₃, and V₄ of the posture information image PS are extracted as feature points of the depth information section MK-2. The length of the line segment V₃V₄ indicates the depth of the spatial display A1. The length of the line segment V₂V₄ indicates the height of the spatial display A1. The angle V₂V₃V₄ indicates an inclination angle θ of the screen SCR with respect to the installation surface GD.

When the shape of the posture information image PS is aligned with the cross-sectional shape of the spatial display A1, the angle φ would be 90°. However, information necessary for specifying the depth of the virtual space VS is the angle V₂V₃V₄, the angle V₃V₂V₄, the depth D, or the height H. For example, when one of a combination of the line segment V₂V₄ and the angle V₃V₂V₄, or a combination of the line segment V₄V₃ and the angle V₂V₃V₄, is obtained, or the length of the line segment V₂V₄ and the length of the line segment V₃V₄ are obtained, the necessary depth information can be uniquely determined. Therefore, as long as the image includes coded information of these, the shape of the posture information image PS is not limited to that in FIG. 5. In this case, the angle φ might not necessarily be 90°.

For example, the depth information section MK-2 can include, as the posture information image PS, an image including coded information, specifically, the inclination angle θ of the screen SCR with respect to the installation surface GD, the inclination direction, or the height of the screen SCR in the direction orthogonal to the installation surface GD. In the present disclosure, examples of coding methods include geometric coding that expresses information as a geometric shape of a figure. However, it is also allowable to use a coding method in which information is expressed by a numerical value or a code (such as a barcode or a QR code (registered trademark)).

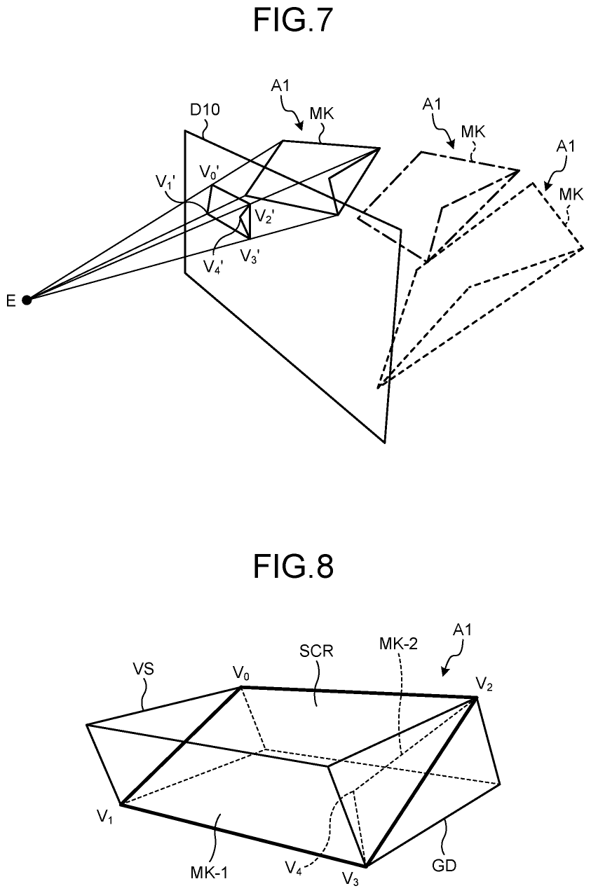

FIG. 6 is a diagram illustrating a state in which the spatial region marker image MK is displayed on each spatial display A1. FIG. 7 is a diagram of the spatial region marker image MK of each spatial display A1 viewed from a camera viewpoint E.

The plurality of spatial displays A1 is sparsely arranged in a state of being spaced apart from each other. The spatial region marker imaging device A5 captures the spatial region marker image MK of each spatial display A1 from a camera viewpoint having position and posture (imaging direction) specified in advance. The spatial region marker imaging device A5 outputs the captured image in which the spatial region marker images MK of all the spatial displays A1 are contained within the same angle of view to the spatial information measuring/managing device A4 as the entire scene image D10.

The spatial region marker image MK has one or more colors assigned to the spatial display A1 as the marker designation colors C1. Based on the marker designation colors C1, the spatial information measuring/managing device A4 discriminates the individual spatial region marker images MK appearing in the entire scene image D10.

The feature points V₀, V₁, V₂, V₃, and V₄ of the spatial region marker image MK are displayed as points V₀′, V₁′, V₂′, V₃′, and V₄′ in the entire scene image D10. When the points V₀′, V₁′, V₂′, V₃′, and V₄′ are restored as points V₀, V₁, V₂, V₃, and V₄ on the screen SCR using a method such as PnP, three-dimensional coordinates of the points V₀, V₁, V₂, V₃, and V₄ are calculated. The range and the posture of the screen SCRR are calculated based on the three-dimensional coordinates of the points V₀, V₁, V₂, V₃, and V₄. The position, shape, and size of the virtual space VS are calculated based on the range and posture of the screen SCR.

The depth information section MK-2 is displayed at a position having a specific positional relationship with the panel information section MK-1 determined based on the height direction of the screen SCR. In the example of FIG. 5, the depth information section MK-2 is displayed at the right end of the panel information section MK-1 when the panel information section MK-1 is viewed in a state where the line segment V₀V₂ corresponding to the upper side of the screen SCR comes at the top side. With this configuration, the positions of the upper side and the lower side of the screen SCR are specified based on the positional relationship between the panel information section MK-1 and the depth information section MK-2.

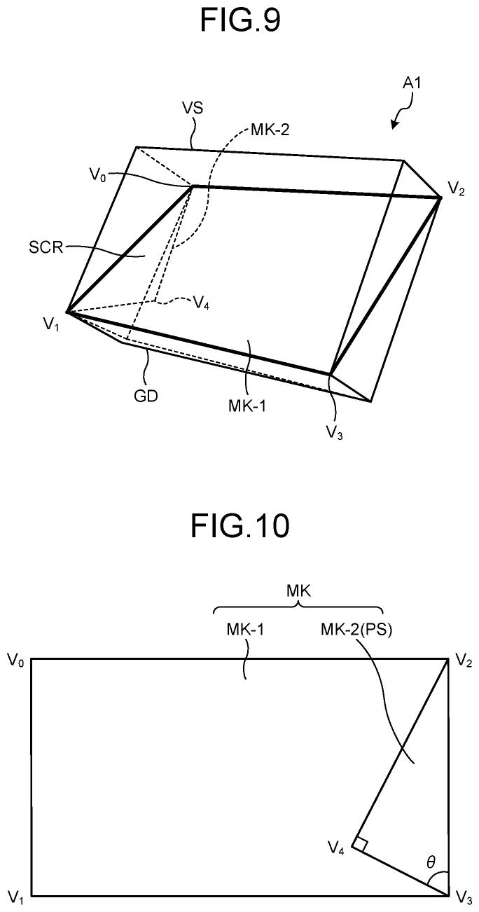

FIGS. 8 and 9 are diagrams illustrating variations of relative positions of the screen SCR, the installation surface GD, and the virtual space VS.

In the example of FIG. 8, the line segment V₀V₂ corresponds to the upper side of the screen SCR. Accordingly, the depth information section MK-2 is displayed on the side closer to the line segment V₂V₃. In the example of FIG. 9, the line segment V₁V₃ corresponds to the upper side of the screen SCR. Accordingly, the depth information section MK-2 is displayed on the side closer to the line segment V₀V₁.

In FIGS. 8 and 9, spaces occupied by the screen SCR are equal to each other. However, the positional relationship between the installation surface GD and the screen SCR in FIG. 9 is different from that in FIG. 8, and thus, the position, shape, and size of the generated virtual space VS in FIG. 9 are also different from those in FIG. 8.

In a case where the installation surface GD is fixed to a horizontal plane or the like, the position, shape, and size of the virtual space VS are uniquely determined using the position and range of the screen SCR calculated based on the panel information section MK-1. In this case, the spatial region marker image MK need not include the depth information section MK-2. However, in a case where the installation position of the spatial display A1 is unknown, it is preferable to specify the positional relationship between the installation surface GD and the screen SCR using the depth information section MK-2.

FIGS. 10 to 16 are diagrams illustrating variations of the spatial region marker image MK.

FIG. 10 includes the depth information section MK-2 generated using the coding method similar to the method in FIG. 5. In the example of FIG. 10, the inclination angle θ of the screen SCR is greater than 45°, and the height of the screen SCR is greater than the depth.

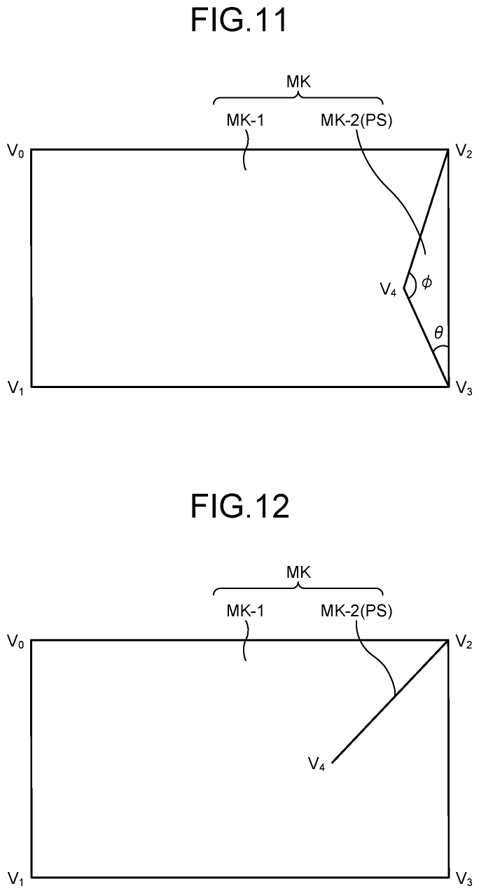

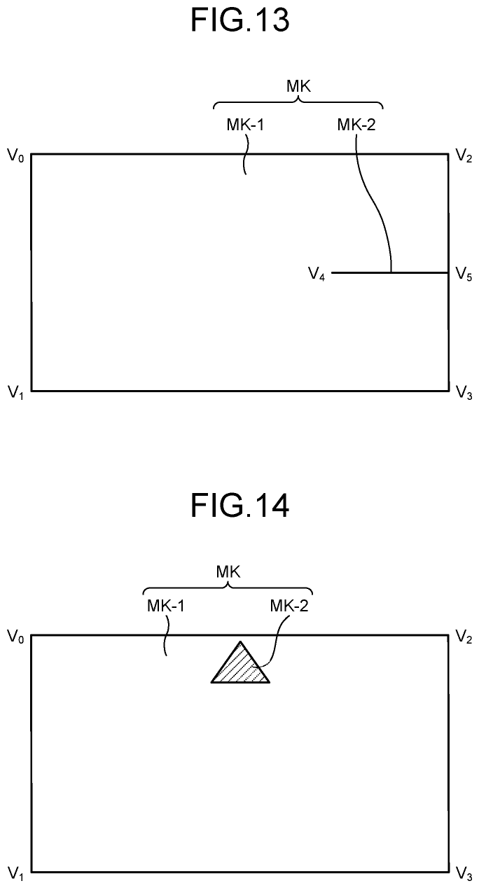

In the example of FIG. 11, the angle φ is displayed as an obtuse angle. In the example of FIG. 12, an image displaying only the line segment V₂V₄ and the angle V₄V₂V₃ is displayed as the posture information image PS. In the example of FIG. 13, an image in which a portion from the point V₄ to a position V₅ where perpendicular lines to the line segment V₂V₃ intersect is displayed as a line segment is displayed as the posture information image PS.

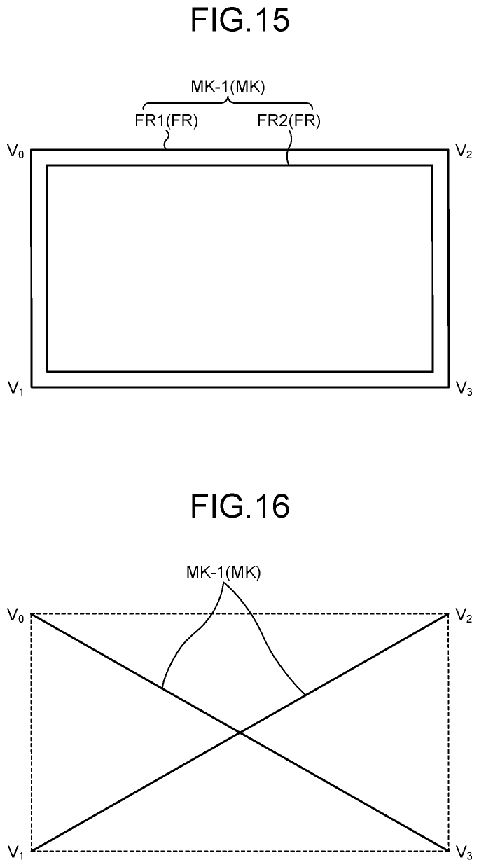

In the example of FIG. 14, a symbol indicating the upper side of the screen SCR is displayed as the depth information section MK-2. In the example of FIG. 15, multiple colors (for example, two colors) are assigned as the marker designation color C1 to one spatial display A1. The panel information section MK-1 is displayed as overlapping frame bodies in which individual frames FR are drawn in different marker designation colors C1. In a case where there are a large number of spatial displays A1, using one color for the marker designation color C1 would lead to a failure in obtaining sufficient discriminability. In this case, it is allowable to use a method in which N colors are assigned to the outer frame FR1 and M colors are assigned to the inner frame FR2, and the N×M colors are used for individual discrimination.

In the example of FIG. 16, an X-shaped figure indicating two diagonals of the screen SCR is displayed as the panel information section MK-1. The positions of the four corners of the screen SCR are specified also in the example of FIG. 16, making it possible to detect the position and posture of the screen SCR.

The above-described spatial region marker image MK is an example, and it is also possible to generate the spatial region marker image MK with another graphic as an alternative. The spatial region marker image MK may include a figure or a character indicating the individual information of the spatial display as the individual information section. The individual information section includes, for example, information such as resolution of the spatial display A1, optical parameters of a lenticular lens, a color depth (8/10/12 bit) of the spatial display A1, a frame rate, and a high dynamic range (HDR) transfer function.

### [1-1-4. Spatial Information Measuring/Managing Device]

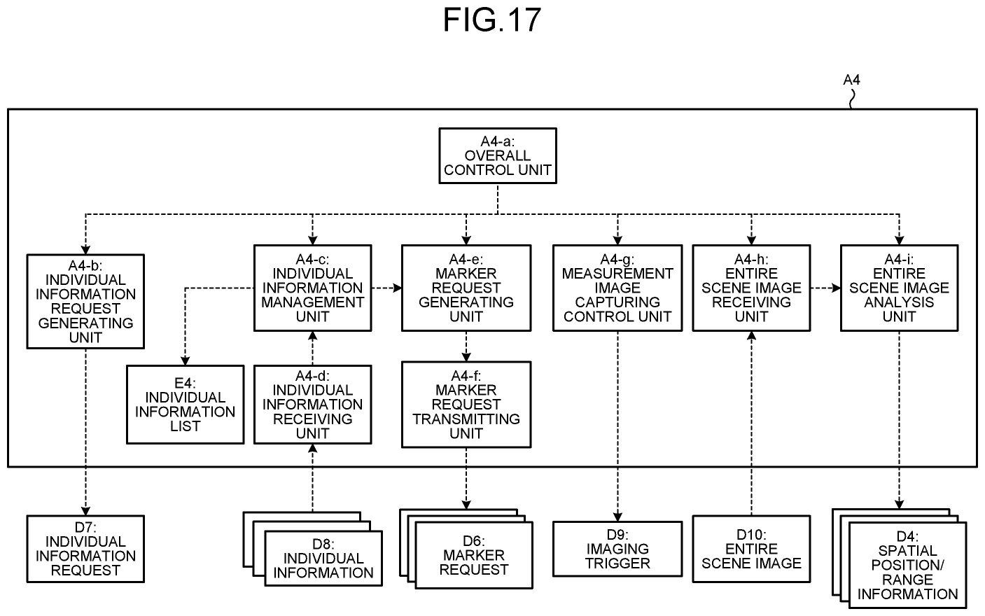

FIG. 17 is a block diagram illustrating a functional configuration of the spatial information measuring/managing device A4.

The spatial information measuring/managing device A4 includes: an overall control unit A4-a; an individual information request generating unit A4-b; an individual information management unit A4-c; an individual information receiving unit A4-d; a marker request generating unit A4-e; a marker request transmitting unit A4-f; a measurement image capturing control unit A4-g; an entire scene image receiving unit A4-h; and an entire scene image analysis unit A4-i.

The overall control unit A4-a instructs the individual information request generating unit A4-b to transmit the individual information request D7 to all the spatial displays A1 connected to a network. Next, the overall control unit A4-a instructs the individual information receiving unit A4-d to receive the individual information D8 returned from each spatial display A1.

The individual information request generating unit A4-b performs request data transmission by broadcast transmission for a specific address range on a subnet or by multicast distribution for a plurality of specific IPs. The request data includes attribute information indicating what type of information should be returned to each spatial display A1. The attribute information includes, for example, information such as the width, height, and depth of the virtual space VS that can be used for 3D display by the spatial display A1, and the color gamut and bit depth of the spatial display A1.

The individual information receiving unit A4-d analyzes response data returned from each spatial display A1, and extracts the individual information D8. The individual information management unit A4-c registers the individual information D8 of each spatial display A1 to an individual information list E4. The individual information management unit A4-c accumulates the individual information list E4 in a temporary/permanent storage device in the spatial information measuring/managing device A4, and shifts the individual information list E4 to a state accessible at any time.

The overall control unit A4-a instructs the marker request generating unit A4-e to generate marker image information corresponding to each spatial display A1 from the individual information D8. The marker image information is image information used for generating the spatial region marker image MK. The marker request generating unit A4-e generates a marker request D6 including marker image information, for each spatial display A1. The marker request generating unit A4-e transmits the generated marker request D6 to the corresponding spatial video reproduction device A2.

For example, the marker request generating unit A4-e refers to the individual information D8 managed by the individual information management unit A4-c, and acquires a total number N1 of management information. The marker request generating unit A4-e associates the spatial display A1 and the spatial video reproduction device A2 that supplies the panel image D2 to the spatial display A1, as one corresponding pair. The marker request generating unit A4-e adds an index to each corresponding pair.

The marker request generating unit A4-e assigns a marker designation color C1 to each corresponding pair. The marker designation color C1 may indicate any color of a palette determined in advance in the system, or may directly represent each of RGB. The marker request generating unit A4-e generates the marker request D6 for each corresponding pair by including information of the marker designation color C1 in the marker image information. The marker request transmitting unit A4-f transmits the marker request D6 to the spatial video reproduction device A2 connected to the network.

After waiting for completion of the above-described procedure, the overall control unit A4-a instructs the measurement image capturing control unit A4-g to transmit an imaging trigger D9 to the spatial region marker imaging device A5. The imaging trigger D9 is a signal instructing the spatial region marker imaging device A5 connected by the camera control standard such as ONVIF or USB Vision to capture the measurement image (spatial region marker image MK).

The overall control unit A4-a instructs the entire scene image receiving unit A4-h to receive the entire scene image D10 captured in response to the imaging trigger D9. The entire scene image receiving unit A4-h receives the entire scene image D10 transmitted from the spatial region marker imaging device A5 following the imaging instruction from the measurement image capturing control unit A4-g. The entire scene image D10 includes a captured image of the spatial region marker image MK displayed on each spatial display A1.

The overall control unit A4-a analyzes the entire scene image D10 using the entire scene image analysis unit A4-i. The entire scene image analysis unit A4-i is an image analysis unit that analyzes a captured image of the spatial region marker imaging device A5. The image analysis is performed using a method such as the PnP method. Based on the captured image, the entire scene image analysis unit A4-i generates the spatial position/range information D4 of the virtual space VS in which the spatial display A1 performs 3D display, for each spatial display A1.

### [1-1-5. Spatial Region Marker Imaging Device]

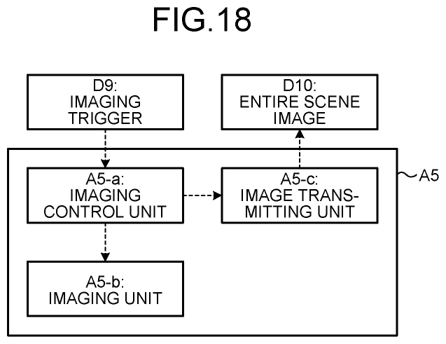

FIG. 18 is a block diagram illustrating a functional configuration of the spatial region marker imaging device A5.

The spatial region marker imaging device A5 includes an imaging control unit A5-a, an imaging unit A5-b, and an image transmitting unit A5-c.

The imaging control unit A5-a receives the imaging trigger D9 via the ONVIF or the USB Vision, and uses the imaging unit A5-b to image the spatial display A1 on which the spatial region marker image MK is displayed.

The imaging unit A5-b includes an optical system having a wide viewing angle, such as a wide-angle lens or a fisheye lens. The imaging unit A5-b images a plurality of spatial displays A1 arranged as a stretch of display in the real space. The spatial display A1 displays the spatial region marker image MK. The image transmitting unit A5-c transmits a captured image being the spatial region marker image MK of each spatial display A1 to the spatial information measuring/managing device A4.

### 1-2. Information Processing Method

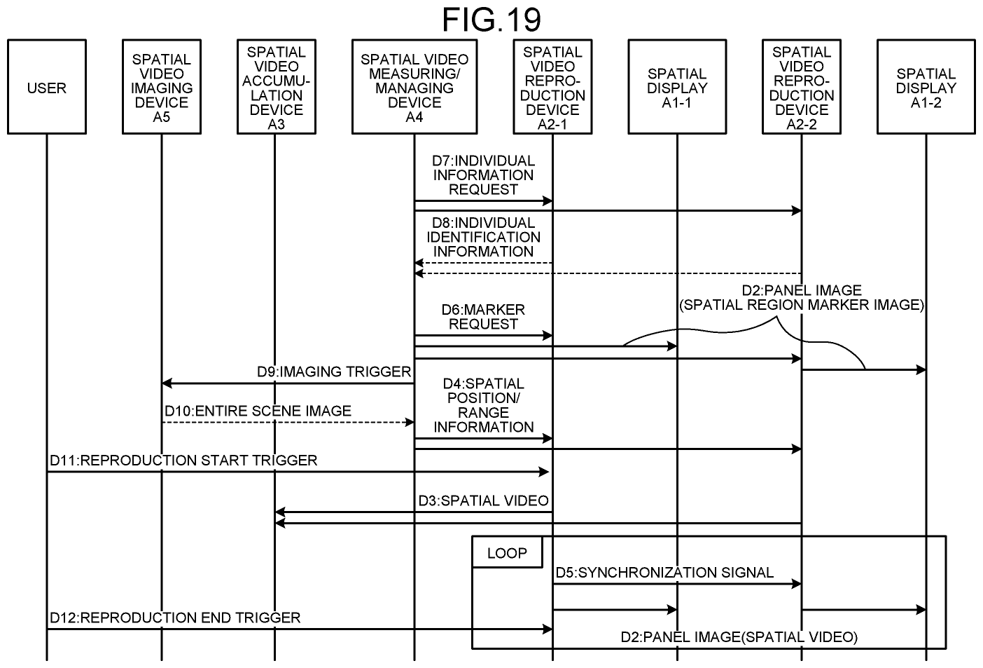

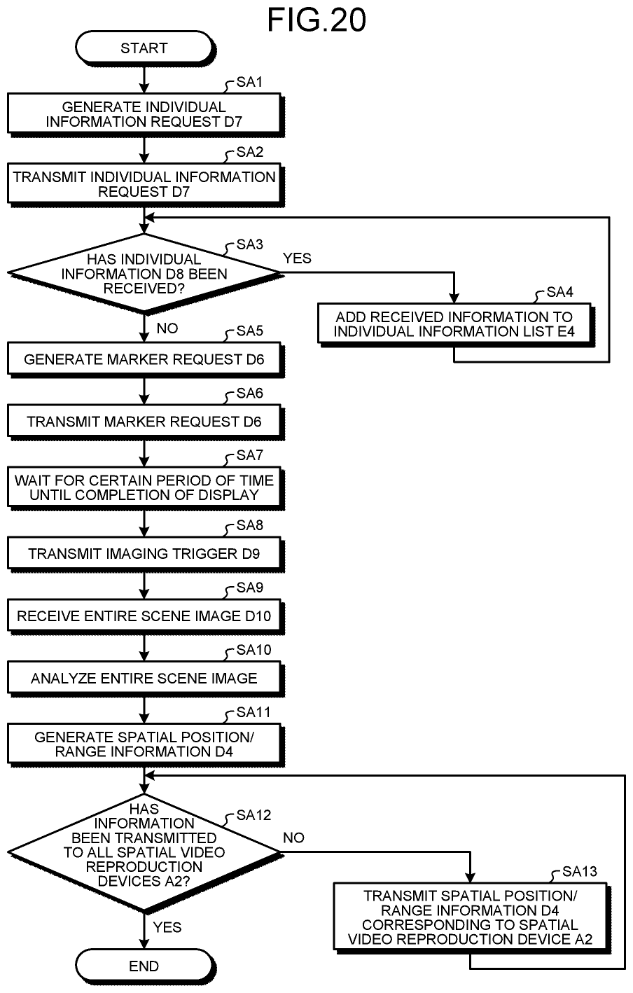

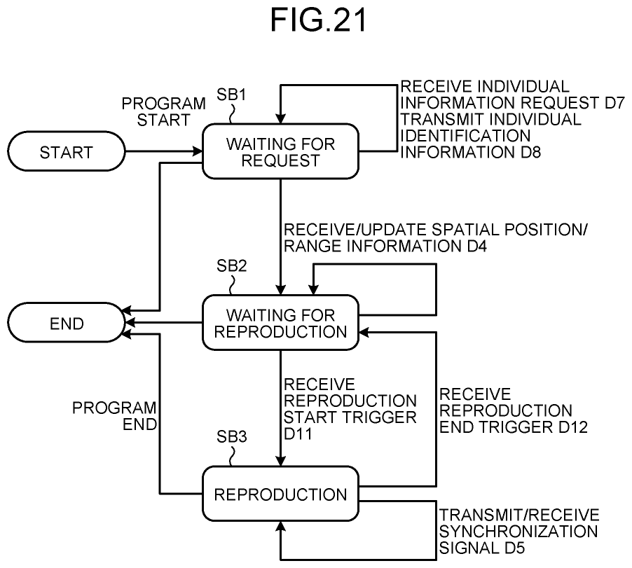

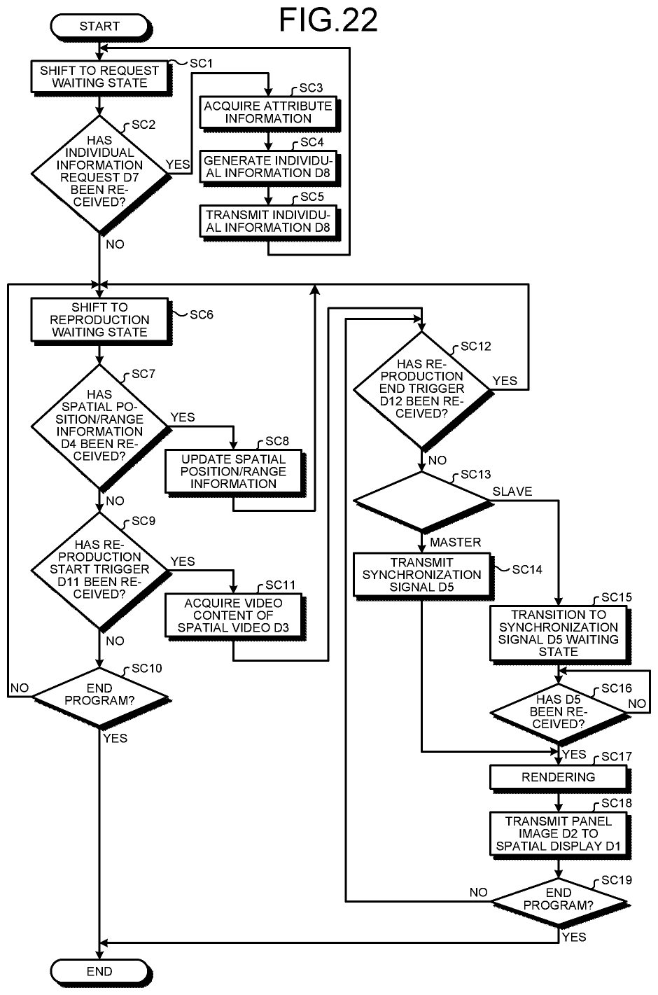

FIG. 19 is a diagram illustrating an overall sequence of information processing performed by the display system DS1. FIG. 20 is a flowchart illustrating spatial information measurement processing. FIG. 21 is a state transition diagram of the spatial video reproduction device A2. FIG. 22 is a flowchart of reproduction processing.

The information processing of the display system DS1 includes measurement processing of spatial information and reproduction processing of the spatial video D3. Hereinafter, an example of the measurement processing and the reproduction processing will be described with reference to FIGS. 19 to 22. In FIG. 19, the individual spatial displays A1 are distinguished from each other by numbers added after their reference numerals. The similar applies to a method of distinguishing the individual spatial video reproduction devices A2.

### [1-2-1. Spatial Information Measurement Processing]

First, spatial information measurement processing will be described with reference to FIGS. 19 and 20.

In step SA1, the spatial information measuring/managing device A4 generates an individual information request D7. In step SA2, the spatial information measuring/managing device A4 transmits the individual information request D7 to each spatial video reproduction device A2.

In step SA3, the spatial information measuring/managing device A4 determines whether the individual information D8 has been received. When it is determined in step SA3 that the individual information D8 has been received (step SA3: Yes), the processing proceeds to step SA4. In step SA4, the spatial information measuring/managing device A4 registers the received individual information D8 to the individual information list E4, and returns to step SA3. The above-described processing is repeated until the individual information D8 has been received from all the spatial displays A1.

When it is determined in step SA3 that the individual information D8 has not been received (step SA3: No), it is regarded that the individual information D8 has been acquired from all the spatial displays A1, and the processing proceeds to step SA5. In step SA5, the spatial information measuring/managing device A4 generates a marker request D6 for each spatial display A1.

In step SA6, the spatial information measuring/managing device A4 transmits each marker request D6 to the corresponding spatial video reproduction device A2. Each spatial video reproduction device A2 generates a spatial region marker image MK based on the received marker request D6, and transmits the generated spatial region marker image MK to the corresponding spatial display A1.

In step SA7, the spatial information measuring/managing device A4 waits for a certain period of time until completion of the display of the spatial region marker image MK on all the spatial displays A1. When the waiting is released, the spatial information measuring/managing device A4 transmits, in step SA8, the imaging trigger D9 to the spatial region marker imaging device A5. In step SA9, the spatial information measuring/managing device A4 receives the entire scene image D10 captured in response to the imaging trigger D9.

In step SA10, the spatial information measuring/managing device A4 performs image analysis on the entire scene image D10. In step SA11, the spatial information measuring/managing device A4 generates the spatial position/range information D4 of each spatial display A1 based on the analysis result. The spatial information measuring/managing device A4 transmits the spatial position/range information D4 of each spatial display A1 to the corresponding spatial video reproduction device A2.

In step SA12, the spatial information measuring/managing device A4 determines whether the spatial position/range information D4 has been transmitted to all the spatial video reproduction devices A2. When it is determined in step SA12 that the spatial position/range information D4 has been transmitted to all spatial video reproduction devices A2 (step SA12: Yes), the spatial information measurement processing ends.

When it is determined in step SA12 that spatial position/range information D4 has not been transmitted to all spatial video reproduction devices A2 (step SA12: No), the processing proceeds to step SC13. In step SC13, the spatial information measuring/managing device A4 transmits the spatial position/range information D4 to the spatial video reproduction device A2 to which transmission has not been performed, and the processing returns to step SA12. The above-described processing is repeated until the spatial position/range information D4 is transmitted to all the spatial video reproduction devices A2.

### [1-2-2. Spatial Video Reproduction Processing]

The reproduction processing of the spatial video D3 will be described with reference to FIGS. 19, 21, and 22.

When a reproduction processing program is started, the display system DS1 enters a request waiting state SB1 in step SC1. In the request waiting state SB1, the display of the spatial video D3 is stopped until the individual information D8 of all the spatial displays A1 has been acquired.

In the request waiting state SB1, first, in step SC2, each spatial video reproduction device A2 determines whether the individual information request D7 has been received from the spatial information measuring/managing device A4. In step SC2, when it is determined that the individual information request D7 has been received (step SC2: Yes), the processing proceeds to step SC3.

In step SC3, the spatial video reproduction device A2 that has received the individual information request D7 communicates with the spatial display A1 as a target, and acquires attribute information from the spatial display A1. In step SC4, the spatial video reproduction device A2 generates the individual information D8 of the spatial display A1 based on the acquired attribute information. In step SC5, the spatial video reproduction device A2 transmits the generated individual information D8 to the spatial information measuring/managing device A4, and returns to step SC2.

In step SC2, when it is determined that all of the spatial video reproduction devices A2 have not been received the individual information request D7 (step SC2: No), it is determined that the individual information D8 of all the spatial displays A1 has already been acquired by the spatial information measuring/managing device A4, and the processing proceeds to step SC6. In step SC6, the display system DS1 shifts to a reproduction waiting state SB2. In the reproduction waiting state SB2, the reproduction of the spatial video D3 is stopped until the spatial position/range information D4 of all the spatial displays A1 has been acquired.

In the reproduction waiting state SB2, first, in step SC7, each spatial video reproduction device A2 determines whether the spatial position/range information D4 has been received from the spatial information measuring/managing device A4. When it is determined in step SC7 that the spatial video reproduction device A2 has received the spatial position/range information D4 (step SC7: Yes), the processing proceeds to step SC8. In step SC8, the spatial video reproduction device A2 updates the spatial position/range information D4 of the corresponding spatial display A1 based on the received spatial position/range information D4, and returns to step SC7.

When it is determined in step SC7 that all of the spatial video reproduction devices A2 have not received the spatial position/range information D4 (step SC7: No), it is considered that the spatial position/range information D4 of all the spatial displays A1 has been updated, and the processing proceeds to step SC9. In step SC9, the reproduction waiting state SB2 is released. After releasing the reproduction waiting state SB2, each spatial video reproduction device A2 determines whether a reproduction start trigger D11 has been received.

In step SC9, when it is determined that the reproduction start trigger D11 has not been received by any spatial video reproduction device A2 (step SC9: No), the processing proceeds to step SC10. In step SC10, the display system DS1 determines whether to end the reproduction processing program. For example, the display system DS1 determines to end the program when having received a program end operation from the user.

When it is determined in step SC10 to end the reproduction processing program (step SC10: Yes), the display system DS1 ends the reproduction processing. When it is determined in step SC10 to not end the reproduction processing program (step SC10: No), the processing returns to step SC6, and the above-described processing is repeated until the end of the reproduction processing program.

In step SC9, when it is determined that the reproduction start trigger D11 has been received by each spatial video reproduction device A2 (step SC9: Yes), the processing proceeds to step SC11. In step SC11, the display system DS1 shifts to a reproduction state SB3 in which the spatial video D3 can be displayed. In the reproduction state SB3, each spatial video reproduction device A2 acquires video content of the spatial video D3 from the spatial video accumulation device A3.

In step SC12, each spatial video reproduction device A2 determines whether a reproduction end trigger D12 has been received. In step SC12, when it is determined that the reproduction end trigger D12 has been received by each spatial video reproduction device A2 (step SC12: Yes), the processing returns to step SC6, and the above-described processing is repeated until the reproduction end trigger D12 is received. In step SC12, when it is determined that the reproduction end trigger D12 has not been received by any spatial video reproduction device A2 (step SC12: No), the processing proceeds to step SC13.

In step SC13, each spatial video reproduction device A2 determines whether the spatial video reproduction device A2 itself is Master or Slave. In step SC13, when it is determined that the spatial video reproduction device A2 is Master, the processing proceeds to step SC14. In step SC14, the spatial video reproduction device A2 determined as Master transmits the synchronization signal D5 to Salve, and proceeds to step SC17.

In step SC13, when it is determined that the spatial video reproduction device A2 is Slave, the processing proceeds to step SC15. In step SC15, Slave transitions to a reception waiting state for the synchronization signal D5. In step SC16, Slave determines whether the synchronization signal D5 has been received from Master. When it is determined in step S16 that the synchronization signal D5 has not been received (step S16: No), the processing returns to step S16, and the above-described processing is repeated until the synchronization signal D5 is received. When it is determined in step S16 that the synchronization signal D5 has been received (step S16: Yes), the processing proceeds to step SC17.

In step SC17, based on the spatial position/range information D4 and the viewpoint position E2, each spatial video reproduction device A2 performs rendering processing of the spatial video D3 and generates a panel image D2. In step SC18, each spatial video reproduction device A2 transmits the generated panel image D2 to the corresponding spatial display A1 at a timing corresponding to the synchronization signal D5.

In step SC19, the display system DS1 determines whether to end the reproduction processing program. When it is determined in step SC19 to end the reproduction processing program (step SC19: Yes), the display system DS1 ends the reproduction processing. When it is determined in step SC19 to not end the reproduction processing program (step SC19: No), the processing returns to step SC12, and the above-described processing is repeated until end of the reproduction processing program.

### 1-3. Hardware Configuration Example

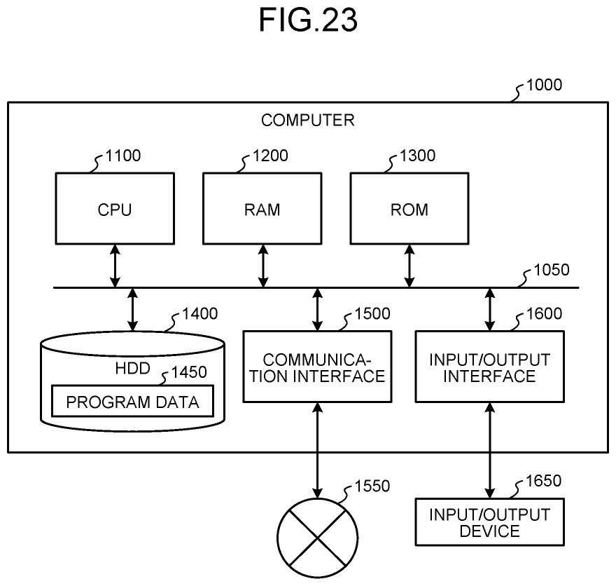

FIG. 23 is a diagram illustrating a hardware configuration example of the display system DS1.

The display system DS1 is an information processing device that processes various types of information. The display system DS1 is implemented by a computer 1000 having a configuration as illustrated in FIG. 23, for example. The computer 1000 includes a CPU 1100, RAM 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program stored in the ROM 1300 or the HDD1400 so as to control each of components. For example, the CPU 1100 develops the program stored in the ROM 1300 or the HDD1400 into the RAM 1200 and executes processing corresponding to various programs.

The ROM 1300 stores a boot program such as a basic input output system (BIOS) executed by the CPU 1100 when the computer 1000 starts up, a program dependent on hardware of the computer 1000, or the like.

The HDD1400 is a non-transitory computer-readable recording medium that records a program executed by the CPU 1100, data used by the program, or the like. Specifically, the HDD1400 is a recording medium that records an information processing program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting an input/output device 1650 with the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on a predetermined recording medium. Examples of the media include optical recording media such as a digital versatile disc (DVD), a magneto-optical recording medium such as a magneto-optical disk (MO), a tape medium, a magnetic recording medium, and semiconductor memory.

For example, when the computer 1000 functions as the display system DS1, the CPU 1100 of the computer 1000 executes a program loaded on the RAM 1200 to implement the functions of each unit of the spatial video reproduction device A2 and the spatial information measuring/managing device A4. In addition, the HDD1400 stores a program according to the present disclosure and data within the spatial video accumulation device A3. While the CPU 1100 executes program data 1450 read from the HDD1400, the CPU 1100 may acquire these programs from another device via the external network 1550, as another example.

### 1-4. Effects

The display system DS1 includes the entire scene image analysis unit A4-i and the content rendering unit A2-c. Based on the captured image of the spatial region marker image MK displayed on the spatial display A1, the entire scene image analysis unit A4-i generates the spatial position/range information D4 of the virtual space VS in which the spatial display A1 performs 3D display. Based on the spatial position/range information D4 and the viewpoint position E2, the content rendering unit A2-c performs rendering processing on the spatial video D3 presented in the virtual space VS. The information processing method of the present embodiment executes the processing of the display system DS1 by a computer. The program of the present embodiment causes the computer to implement the processing of the display system DS1.

With this configuration, the spatial region marker image MK is displayed on the screen SCR of the inclined spatial display A1. The shape of the spatial region marker image MK appearing in the captured image is distorted according to the position and the inclination angle θ of the screen SCR. The position and range of the virtual space VS are accurately specified based on the distortion of the spatial region marker image MK.

The spatial region marker image MK includes the panel information section MK-1 and the depth information section MK-2. The panel information section MK-1 indicates information related to the range of the screen SCR of the spatial display A1. The depth information section MK-2 indicates information related to the depth of the virtual space VS.

This configuration, the depth of the virtual space VS is accurately specified based on the depth information section MK-2.

The depth information section MK-2 is displayed at a position having a specific positional relationship with the panel information section MK-1 based on the height direction of the screen SCR.

With this configuration, the height direction of the screen SCR is specified based on the depth information section MK-2.

The depth information section MK-2 includes an posture information image PS. The posture information image PS indicates posture information of the screen SCR with respect to the installation surface GD of the spatial display A1.

With this configuration, the depth of the virtual space VS is accurately specified based on the posture information of the screen SCR.

The depth information section MK-2 includes, as the posture information image PS, an image after coding the inclination angle θ of the screen SCR with respect to the installation surface GD, the inclination direction, or the height of the screen SCR in the direction orthogonal to the installation surface GD.

With this configuration, by displaying the posture information of the screen SCR as coded information, the depth of the virtual space VS is specified with high accuracy.

The spatial region marker image MK includes the individual information section. The individual information section indicates individual information of the spatial display A1.

With this configuration, the display of the spatial display A1 can be appropriately controlled based on the individual information.

The spatial region marker image MK has one or more colors assigned to the spatial display A1.

With this configuration, it is easy to specify the spatial display A1 by color.

The effects described in the present specification are merely examples, and thus, there may be other effects, not limited to the exemplified effects.

### 2. Second Embodiment

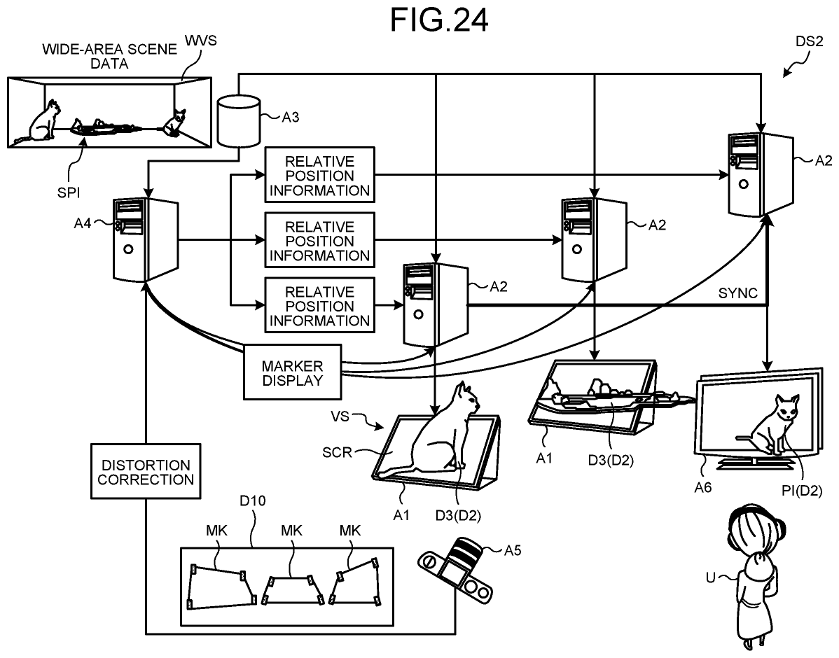

FIG. 24 is a diagram illustrating a schematic configuration of a display system DS2 of a second embodiment.

The present embodiment is different from the first embodiment in that one or more spatial displays A1 among the plurality of spatial displays A1 are each replaced with a 2D display A6. Hereinafter, differences from the first embodiment will be mainly described.

The display system DS2 includes one or more 2D displays A6. The 2D display A6 presents a spatial video D3 observed by the user U in the form of a 2D video PI. The content rendering unit A2-c outputs the spatial video D3 viewed from the viewpoint position E2 of the user U in the form of the 2D video PI for each 2D display A6.

Examples of the 2D display A6 include a known display such as an LCD or an OLED capable of displaying the 2D video PI. In the example of FIG. 24, the number of 2D displays A6 is one, but the number of 2D displays A6 may be two or more.

The 2D display A6 displays a video with little motion, for example. In the example of FIG. 24, a video of a cat resting around a pond is displayed. The video with little motion can be displayed as the 2D video PI with little sense of discomfort. Substituting such a video display means with the 2D display A6 will reduce the cost of the entire system.

### 3. Third Embodiment

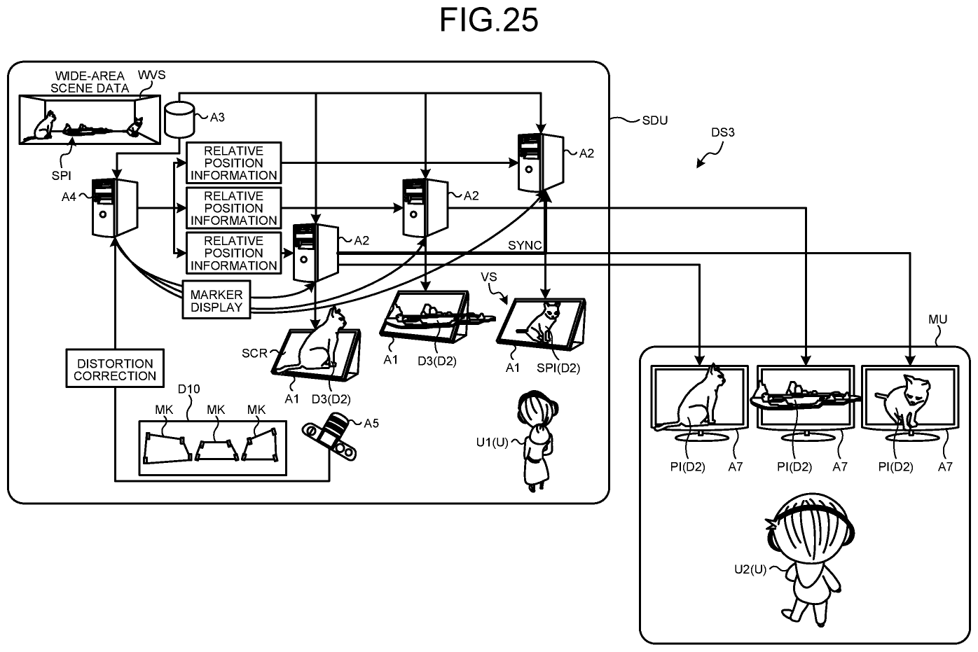

FIG. 25 is a diagram illustrating a schematic configuration of a display system DS3 of a third embodiment.

The present embodiment is different from the first embodiment in that there is provided a monitor display A7 capable of providing the spatial video D3 presented by the spatial display A1 to a third party in the form of a 2D video PI. Hereinafter, differences from the first embodiment will be mainly described.

The display system DS3 includes a spatial video display unit SDU and a monitor unit MU. The spatial video display unit SDU includes one or more spatial displays A1 for performing 3D display of the spatial video D3. The monitor unit MU includes one or more monitor displays A7 corresponding to the respective spatial displays A1. Examples of the monitor display A7 include a known display such as an LCD or an OLED capable of displaying the 2D video PI.

For example, the spatial video display unit SDU is used for a first user U1 to view the spatial video D3. The monitor unit MU is used by a second user U2 (operator) to monitor the operation of the spatial video display unit SDU.

The spatial display A1 and the monitor display A7 associated with each other are connected to an identical spatial video reproduction device A2. The content rendering unit A2-c outputs the spatial video D3 viewed from the viewpoint position E2 of the first user U1 to the spatial display A1 in the form of a 3D video. The content rendering unit A2-c outputs the spatial video D3 viewed from the viewpoint position E2 of the first user U1 to the monitor display A7 in the form of a 2D video PI. This implements a function similar to mirroring. The second user U2 shares the video having the same content as the video watched by first user U1.

### 4. Fourth Embodiment

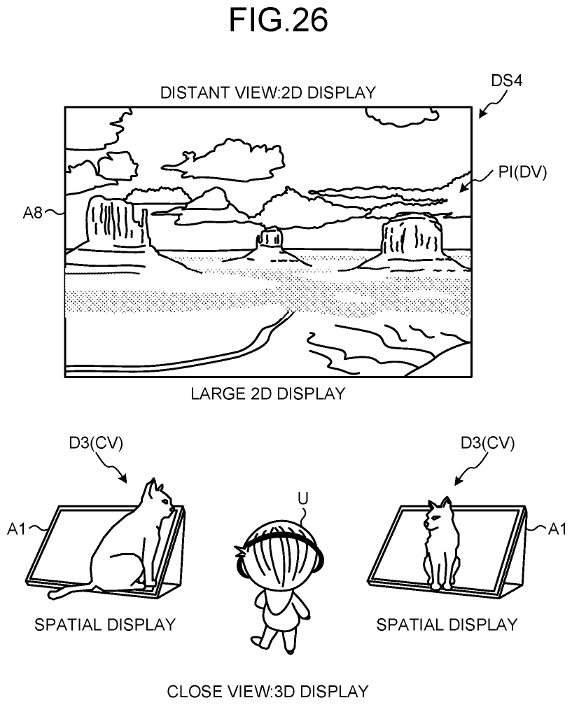

FIG. 26 is a diagram illustrating a display system DS4 according to a fourth embodiment.

In the second embodiment, the spatial video D3 of a local space is replaced with the 2D video PI. In contrast, in the present embodiment, the spatial video D3 of a distant view DV covering the entire wide-area scene SPI is replaced with the 2D video PI. The spatial video D3 of a close view CV is displayed as a 3D image on the spatial display A1. The content rendering unit A2-c separates a piece of video content into video content of the close view CV and video content of the distant view DV. The content rendering unit A2-c generates the 2D video PI from the video content of the close view CV, and generates the spatial video D3 from the video content of the distant view DV.

With this configuration, only the video content of the close view CV is displayed as a 3D image, making it possible to reduce the load of the video generation processing. Even though the distant view DV is not displayed as a 3D image, a sense of discomfort is less likely to occur by displaying the distant view DV as a 2D image because the parallax in the case of the distant view DV is small.

### 5. Fifth Embodiment

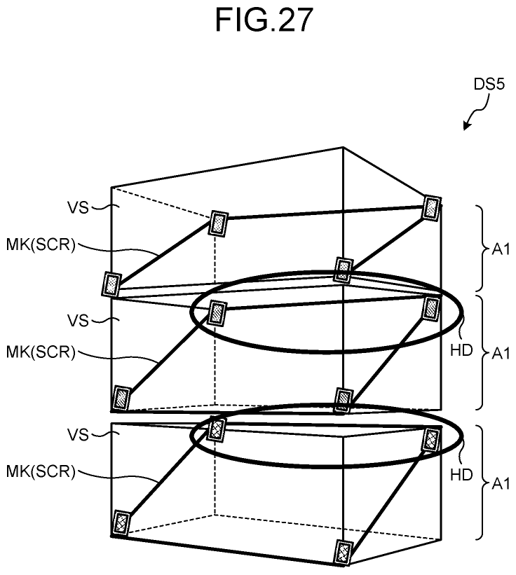

FIG. 27 is a diagram illustrating a display system DS5 according to a fifth embodiment.

The display system DS5 includes a plurality of spatial displays A1 stacked in the height direction. The stacked structure aims to provide the virtual space VS wider in the height direction by stacking the plurality of spatial displays A1. In the stacked structure, a part of the spatial region marker image MK might be hidden by the spatial display A1 arranged at the top. Therefore, information of a hidden portion HD cannot be obtained by performing image analysis on the entire scene image D10.

Nevertheless, in a case where there is previous knowledge that a stacked structure is to be adopted, information of the hidden portion HD can be supplemented based on a known positional relationship between the spatial displays A1. For example, there is no hidden portion HD in the uppermost spatial region marker image MK. Therefore, the spatial position/range information D4 of the lower spatial displays A1 is calculated by linearly expanding the spatial position/range information D4 of the uppermost spatial display A1 in the height direction.

For example, the entire scene image analysis unit A4-i generates the spatial position/range information D4 of the uppermost spatial display A1 based on the entire scene image D10. The entire scene image analysis unit A4-i generates the spatial position/range information D4 of another spatial displays A1 having a known positional relationship with the uppermost spatial display A1, based on the spatial position/range information D4 of the uppermost spatial display A1 and the known positional relationship obtained from the stacked structure.

With this configuration, the spatial position/range information D4 of the other spatial display A1 is easily generated based on the known positional relationship.

### 6. Sixth Embodiment

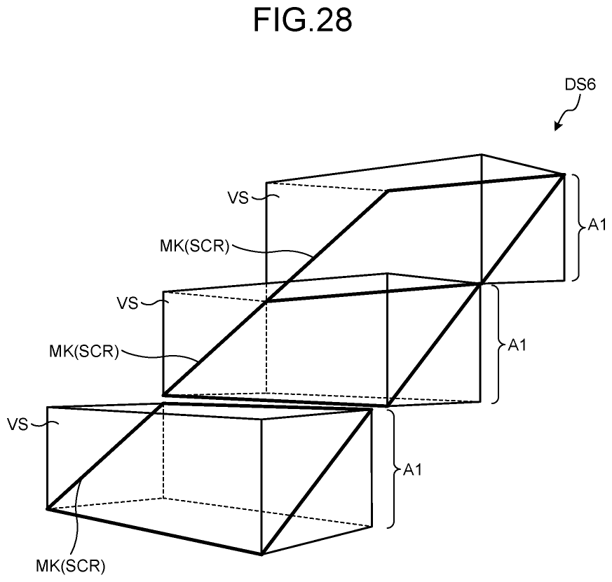

FIG. 28 is a diagram illustrating a display system DS6 according to a sixth embodiment.

The display system DS6 has a plurality of spatial displays A1 tiled along an inclined surface. Spatial positions of the plurality of spatial displays A1 are determined such that the respective screens SCR are arranged on an identical inclined plane. Similarly to the stacked structure, the tiled structure aims to extend the virtual space VS. Also in this case, the spatial position/range information D4 of each spatial display A1 can be generated by using the information related to the tiled regular spatial arrangement in combination.

For example, the entire scene image analysis unit A4-i selects a specific spatial display A1 capable of accurately detecting the position of the spatial region marker image MK from among the plurality of spatial displays A1. The entire scene image analysis unit A4-i generates the spatial position/range information D4 of the selected specific spatial display A1 based on the entire scene image D10. The entire scene image analysis unit A4-i generates the spatial position/range information D4 of the other spatial displays A1 having a known positional relationship with the specific spatial display A1 based on the spatial position/range information D4 of the specific spatial display A1 and the known positional relationship obtained from the tiled structure.

With this configuration, the spatial position/range information D4 of the other spatial display A1 is easily generated as well based on the known positional relationship.

### Supplementary Notes

Note that the present technique can also have the following configurations.

(1)

An information processing device comprising:
an image analysis unit that generates spatial position/range information of a virtual space in which a spatial display performs 3D display, based on a captured image of a marker displayed on the spatial display; and
a content rendering unit that performs rendering processing on a spatial video presented in the virtual space, based on the spatial position/range information and a viewpoint position.
   (2)

The information processing device according to (1),
wherein the marker includes: a panel information section indicating information related to a range of a screen of the spatial display; and a depth information section indicating information related to a depth of the virtual space.
   (3)

The information processing device according to (2),
wherein the depth information section is displayed at a position having a specific positional relationship with the panel information section based on a height direction of the screen.
   (4)

The information processing device according to (2) or (3),
wherein the depth information section includes an posture information image indicating posture information of the screen with respect to an installation surface of the spatial display.
   (5)

The information processing device according to (4),
wherein the depth information section includes, as the posture information image, an image after coding an inclination angle of the screen with respect to the installation surface, an inclination direction, or a height of the screen in a direction orthogonal to the installation surface.
   (6)

The information processing device according to any one of (1) to (5),
wherein the marker includes an individual information section indicating individual information of the spatial display.
   (7)

The information processing device according to any one of (1) to (6), wherein the marker has one or more colors assigned to the spatial display.

(8)

The information processing device according to any one of (1) to (7),
wherein the content rendering unit outputs the spatial video viewed from the viewpoint position in a form of a 2D video.
   (9)

The information processing device according to any one of (1) to (8),
wherein the content rendering unit separates a piece of video content into video content of a close view and video content of a distant view, generates a 2D video from the video content of the close view, and generates the spatial video from the video content of the distant view.
   (10)

The information processing device according to any one of (1) to (9),
wherein the image analysis unit generates the spatial position/range information of another spatial display having a known positional relationship with the spatial display based on the spatial position/range information of the spatial display and the known positional relationship.
   (11)

An information processing method to be executed by a computer, the method comprising:
generating spatial position/range information of a virtual space in which a spatial display performs 3D display, based on a captured image of a marker displayed on the spatial display; and
performing rendering processing on a spatial video presented in the virtual space, based on the spatial position/range information and a viewpoint position.
   (12)

A program causing a computer to implement processing comprising:
generating spatial position/range information of a virtual space in which a spatial display performs 3D display, based on a captured image of a marker displayed on the spatial display; and
performing rendering processing on a spatial video presented in the virtual space, based on the spatial position/range information and a viewpoint position.

### REFERENCE SIGNS LIST

A1 SPATIAL DISPLAY
A2-c CONTENT RENDERING UNIT
A4-i ENTIRE SCENE IMAGE ANALYSIS UNIT (IMAGE ANALYSIS UNIT)
CV CLOSE VIEW
D3 SPATIAL VIDEO
D4 SPATIAL POSITION/RANGE INFORMATION
D8 INDIVIDUAL INFORMATION
D10 ENTIRE SCENE IMAGE (CAPTURED IMAGE)
DS1, DS2, DS3, DS4, DS5, DS6 DISPLAY SYSTEM (INFORMATION PROCESSING DEVICE)
DV DISTANT VIEW
GD INSTALLATION SURFACE
MK SPATIAL REGION MARKER IMAGE (MARKER)
MK-1 PANEL INFORMATION SECTION
MK-2 DEPTH INFORMATION SECTION
E2 VIEWPOINT POSITION
PI 2D VIDEO
PS POSTURE INFORMATION IMAGE
SCR SCREEN
VS VIRTUAL SPACE

1. An information processing device comprising:
an image analysis unit that generates spatial position/range information of a virtual space in which a spatial display performs 3D display, based on a captured image of a marker displayed on the spatial display; and
a content rendering unit that performs rendering processing on a spatial video presented in the virtual space, based on the spatial position/range information and a viewpoint position.

2. The information processing device according to claim 1,
wherein the marker includes: a panel information section indicating information related to a range of a screen of the spatial display; and a depth information section indicating information related to a depth of the virtual space.

3. The information processing device according to claim 2,
wherein the depth information section is displayed at a position having a specific positional relationship with the panel information section based on a height direction of the screen.

4. The information processing device according to claim 2,
wherein the depth information section includes a posture information image indicating posture information of the screen with respect to an installation surface of the spatial display.

5. The information processing device according to claim 4,
wherein the depth information section includes, as the posture information image, an image after coding an inclination angle of the screen with respect to the installation surface, an inclination direction, or a height of the screen in a direction orthogonal to the installation surface.

6. The information processing device according to claim 1,
wherein the marker includes an individual information section indicating individual information of the spatial display.

7. The information processing device according to claim 1, wherein the marker has one or more colors assigned to the spatial display.

8. The information processing device according to claim 1,
wherein the content rendering unit outputs the spatial video viewed from the viewpoint position in a form of a 2D video.

9. The information processing device according to claim 1,
wherein the content rendering unit separates a piece of video content into video content of a close view and video content of a distant view, generates a 2D video from the video content of the close view, and generates the spatial video from the video content of the distant view.

10. The information processing device according to claim 1,
wherein the image analysis unit generates the spatial position/range information of another spatial display having a known positional relationship with the spatial display based on the spatial position/range information of the spatial display and the known positional relationship.

11. An information processing method to be executed by a computer, the method comprising:
generating spatial position/range information of a virtual space in which a spatial display performs 3D display, based on a captured image of a marker displayed on the spatial display; and
performing rendering processing on a spatial video presented in the virtual space, based on the spatial position/range information and a viewpoint position.

12. A program causing a computer to implement processing comprising:
generating spatial position/range information of a virtual space in which a spatial display performs 3D display, based on a captured image of a marker displayed on the spatial display; and
performing rendering processing on a spatial video presented in the virtual space, based on the spatial position/range information and a viewpoint position.
